(19) United States
(12) Patent Application Publication
(10) Pub. No.: US 2019/0108728 A1
(43) Pub. Date: Apr. 11, 2019

(54) SYSTEMS AND METHODS FOR GAMIFIED ENGINEERING EDUCATION

(71) Applicant: JPMorgan Chase Bank, N.A., New York, NY (US)

(72) Inventors: Michael Robert Lyons, Geneva, IL (US); Richard A. Hall, Marysville, OH (US); Michael Frank, Chicago, IL (US); Erin Michelle Perry, Townsend, DE (US); Andrew Renaut, Fairfield, CT (US)

(21) Appl. No.: 16/153,351

(22) Filed: Oct. 5, 2018

Related U.S. Application Data
(60) Provisional application No. 62/569,056, filed on Oct. 6, 2017.

(51) Int. Cl. G07F 17/32; G09B 5/06; G09B 23/00

(52) U.S. Cl. CPC G07F 17/3244; G09B 23/00; G09B 5/06

(57) ABSTRACT

Systems and methods for gamified engineering education are disclosed. Embodiments are directed to an interactive learning exercise designed to allow participants to interact with a complex system, make observations, apply various performance engineering tactics and tools, and optimize the complex system based upon findings. At a high level, the system is a simulated casino floor with multiple pre-defined components, stations, roles, and tasks. The objective of the game is to settle as many player wagers as possible in a set amount of time by “tuning” various aspects of the casino operations. Aspects of the system—the components, stations, roles, tasks, etc.—have analogs in engineering problems. The knowledge gained, including the understanding of how different elements and aspects work with each other, may be applied by the participants to solve future engineering problems.

### RELATED APPLICATIONS

This application claim priority to U.S. Provisional Patent Application Ser. No. 62/569,056, filed Oct. 6, 2017, the disclosure of which is hereby incorporated, by reference, in its entirety.

### BACKGROUND OF THE INVENTION

### 1. Field of the Invention

The present invention generally relates to systems and methods for gamified engineering education.

### 2. Description Of The Related Art

Learning and applying core techniques and skills required to conduct robust performance engineering of systems is complex, difficult, and time consuming. There is limited formal training in the application of various techniques so the acquisition of the necessary knowledge and experience is often the result of years of experience.

### SUMMARY OF THE INVENTION

Systems and methods for gamified performance engineering education are disclosed. In one embodiment, in an information processing apparatus comprising at least one computer processor, a gamified method of teaching engineering principles using a virtual casino environment may include (1) assigning each of a plurality of participants a role selected from the group consisting of players, cashiers, security officers, runners, bankers, pit bosses, casino managers, and an accountant, each participant associated with an electronic device; (2) controlling a plurality of interactions between the participants in a virtual casino environment, wherein, using their respective electronic device: (3) the players roll virtual die to determine a number of wagers to make; (4) the players create virtual wager slips based on the determined number of wagers; (5) the cashiers receive the virtual wager slips and communicate the virtual wager slips to the security officers; (6) the security officer roll a virtual die and annotate the virtual wager slips with the number on the virtual die; (7) the runners receive the annotated virtual wager slips and communicate the annotated virtual wager slips to the bankers; (8) the bankers roll a virtual die until the number on the virtual die matches the number on the annotated virtual wager slips, and the bankers further annotate the virtual wager slips with the number of rolls of the virtual die needed to match the number on the virtual wager slip; (9) the runners receive the further annotated virtual wager slips and communicate the further annotated virtual wager slips to the cashiers; (10) the cashiers settle the wagers by matching the further annotated wager slips to the wager slips and returning the further annotated wager slips to the player that submitted the wager slip; (11) the players report the settled wager to the accountant; (12) the pit bosses monitor the activity of the players, the cashiers, and the bankers, and report the activity to the floor managers; and (13) the floor managers report the activity to the casino manager.

In one embodiment, the number of wagers may be based on the virtual die role being odd or even.

In one embodiment, the virtual wager slips, the annotated virtual wager slips, and the further annotated virtual wager slips may be communicated electronically.

In one embodiment, the runners may communicate the annotated virtual wager slips to the bankers and communicate the further annotated virtual wager slips to the cashiers by completing a challenge on their electronic devices. The challenge may be the completion of a graphical maze, a riddle, a math problem, etc.

In one embodiment, the method may further include updating a dashboard based on the settled wagers received by the accountant.

In one embodiment, the method may further include the casino managers submitting a first resource reallocation request following a first completion of the simulation, and repeating the first simulation with additional resources identified in the first resource reallocation request. The additional resources may include a first assignment of additional pit bosses and floor managers.

In one embodiment, the method may further include the casino managers submitting a second resource reallocation request following a second completion of the simulation, and repeating the second simulation with additional resources identified in the second resource reallocation request. The resource reallocation may include a second assignment of additional pit bosses and floor managers.

In another embodiment, a gamified system for teaching engineering principles using a virtual casino environment may include an electronic device comprising at least one computer processor; and a plurality of participant electronic devices, each participant electronic device associated a plurality of participant, each participant may be assigned a role selected from the group consisting of players, cashiers, security officers, runners, bankers, pit bosses, casino managers, and an accountant. A computer program executed by the electronic device controls a plurality of interactions between the participants in a virtual casino environment, wherein, using their respective electronic device: (1) the players roll virtual die to determine a number of wagers to make; (2) the players create virtual wager slips based on the determined number of wagers; (3) the cashiers receive the virtual wager slips and communicate the virtual wager slips to the security officers; (4) the security officer roll a virtual die and annotate the virtual wager slips with the number on the virtual die; (5) the runners receive the annotated virtual wager slips and communicate the annotated virtual wager slips to the bankers; (6) the bankers roll a virtual die until the number on the virtual die matches the number on the annotated virtual wager slips, and the bankers further annotate the virtual wager slips with the number of rolls of the virtual die needed to match the number on the virtual wager slip; (7) the runners receive the further annotated virtual wager slips and communicate the further annotated virtual wager slips to the cashiers; (8) the cashiers settle the wagers by matching the further annotated wager slips to the wager slips and returning the further annotated wager slips to the player that submitted the wager slip; (9) the players report the settled wager to the accountant; (10) the pit bosses monitor the activity of the players, the cashiers, and the bankers, and report the activity to the floor managers; and (11) the floor managers report the activity to the casino manager.

In one embodiment, the number of wagers may be based on the virtual die role being odd or even.

In one embodiment, the virtual wager slips, the annotated virtual wager slips, and the further annotated virtual wager slips may be communicated electronically.

In one embodiment, the runners may communicate the annotated virtual wager slips to the bankers and communicate the further annotated virtual wager slips to the cashiers by completing a challenge on their electronic devices. The challenge may be the completion of a graphical maze, a riddle, a math problem, etc.

In one embodiment, the computer program may update a dashboard based on the settled wagers received by the accountant.

In one embodiment, the casino managers may submit a first resource reallocation request following a first completion of the simulation, and the first simulation may be repeated with additional resources identified in the first resource reallocation request. The additional resources may include a first assignment of additional pit bosses and floor managers.

In one embodiment, the casino managers may submit a second resource reallocation request following a second completion of the simulation, and the second simulation may be repeated with additional resources identified in the second resource reallocation request. The resource reallocation may include a second assignment of additional pit bosses and floor managers.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for gamified engineering education according to one embodiment;

FIG. 2 depicts an exemplary initial table setup according to one embodiment;

FIGS. 3A-3L depicts exemplary role descriptions according to one embodiment;

FIG. 4 depicts an example session overview according to one embodiment;

FIG. 5 depicts an example game process according to one embodiment; and

FIG. 6 depicts a system for gamified engineering education according to another embodiment.

### DETAILED DESCRIPTION OF PREFERRED EMBODIMENTS

Systems and methods for gamified engineering education are disclosed. Embodiments are directed to an interactive learning exercise designed to allow participants to interact with a complex system, make observations, apply various performance engineering tactics and tools, and optimize the complex system based upon findings. At a high level, the system is a simulated casino floor with multiple pre-defined components, stations, roles, and tasks. The objective of the game is to settle as many player wagers as possible in a set amount of time by “tuning” various aspects of the casino operations. Aspects of the system—the components, stations, roles, tasks, etc.—have analogs in engineering problems. The knowledge gained, including the understanding of how different elements and aspects work with each other, may be applied by the participants to solve future engineering problems.

In embodiments, the exercise may be performed using one or more computer processors. For example, in one embodiment, the exercise may be performed virtually using one or more computer systems.

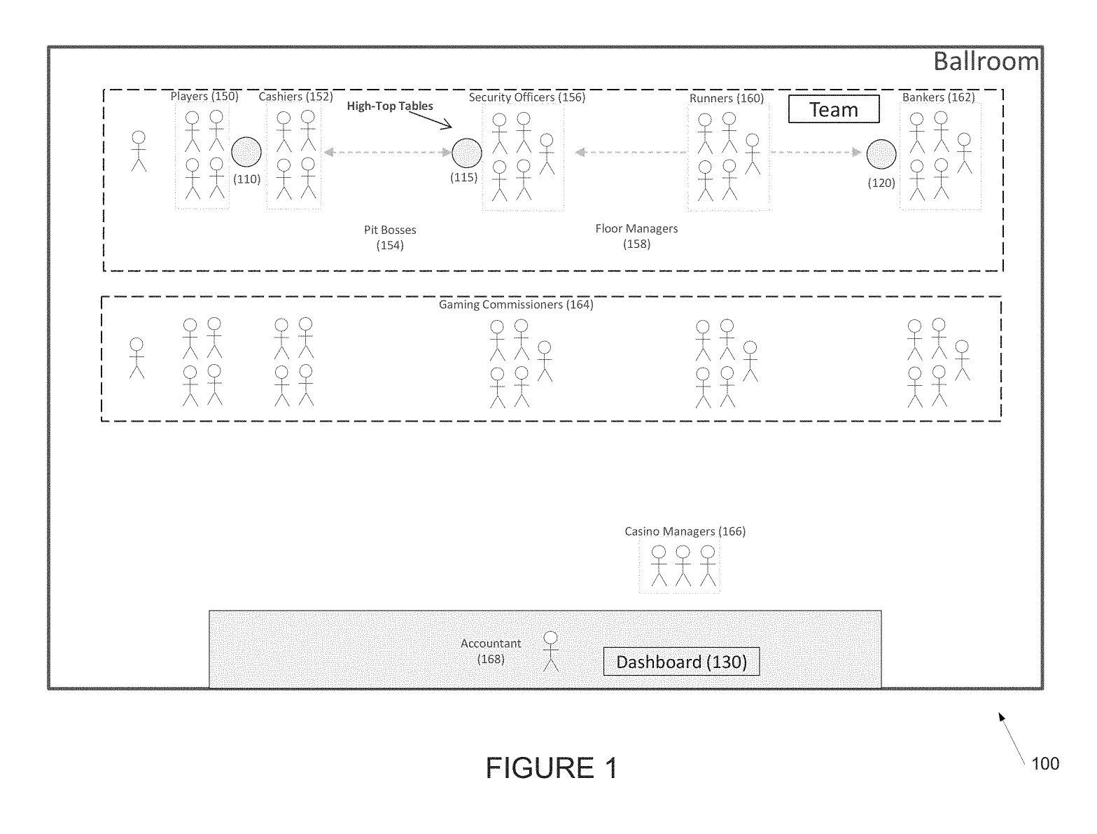

Referring to FIG. 1, a system for gamified engineering education is disclosed according to one embodiment. System 100 may be set in room (e.g., a ballroom at a hotel, conference center, etc.). System 100 may include gameplay tables 110, 115, 120, dashboard 130, and participants. Participants may include players 150, cashiers 152, pit bosses 154, security officers 156, floor managers 158, runners 160, bankers 162, gaining commissioners 164, casino managers 166, and accountant 168.

The participants may assume roles that may be associated with a casino. For example:

Casino mangers 166 may decides how to allocate resources across the various parts of the casino in order to minimize delay and maximize the number of wagers that can be settled;

Players 150 may submit wager slips to cashiers and wait for their wagers to be settled;

Cashiers 152 may attend to players 150 by gathering their wager slips and submitting them to security officers for handling;

Security officers 156 may encrypt the wagers;

Runners 160 may move wager slips between security officers 156 and bankers 162, and then between bankers 162 and cashiers 152;

Bankers 162 may decrypt and settle wagers;

Accountants 168 may track various metrics including the total number of settled wagers;

Pit Boss 154 may observe specific actions as requested by Casino Managers 166 and report on it to Floor Managers 158;

Floor Managers 158 may take responses from Pit Bosses 154 and update Casino Manager Dashboard 130;

Gaining Commissioners 160 may observe the ongoing activity (e.g., What is happening? Why? Improvement suggestions?).

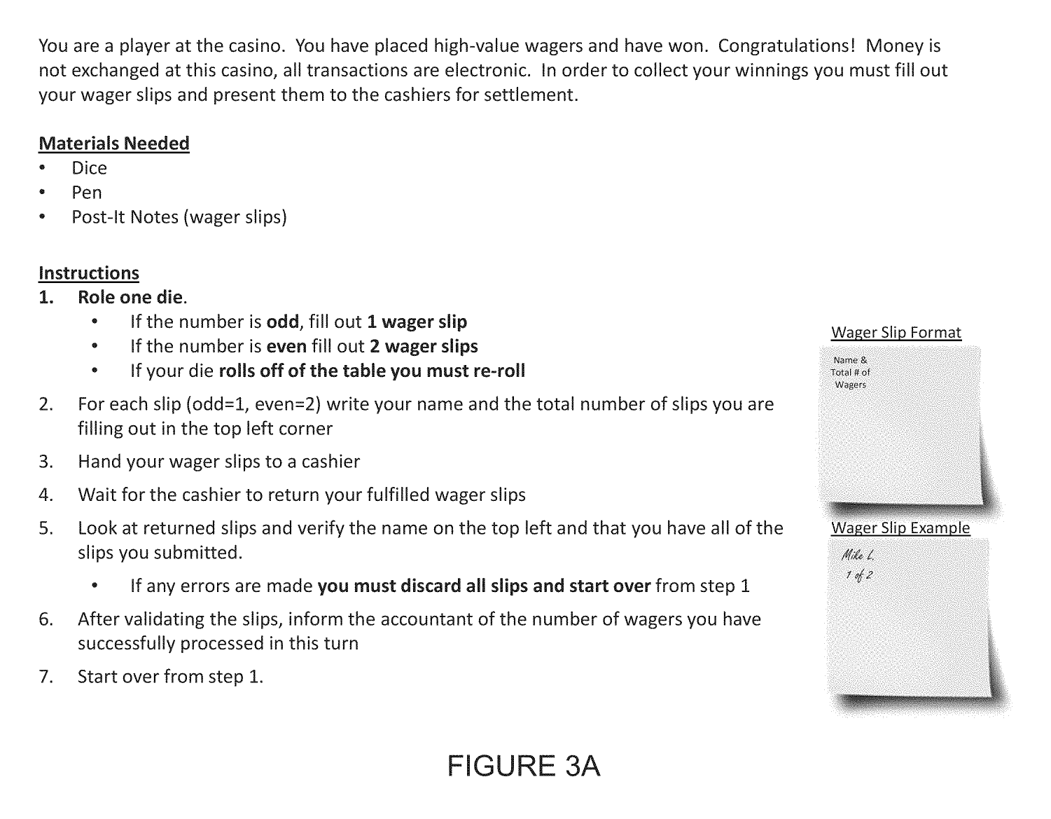

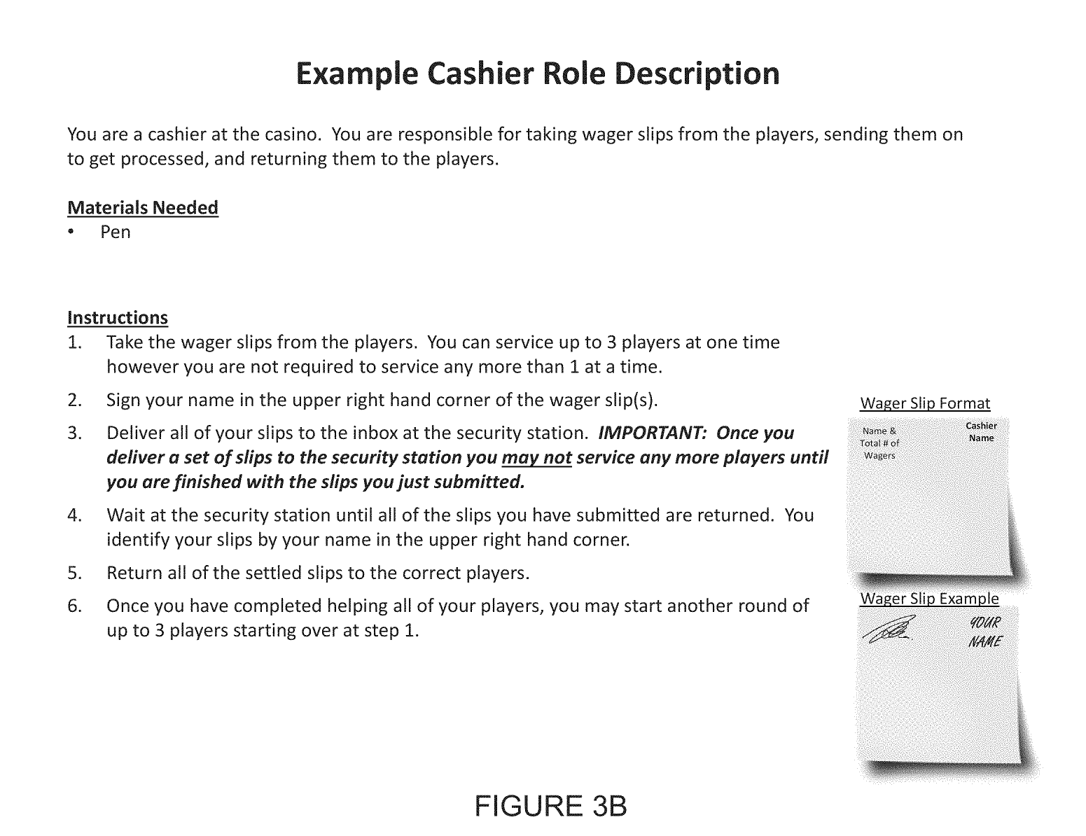

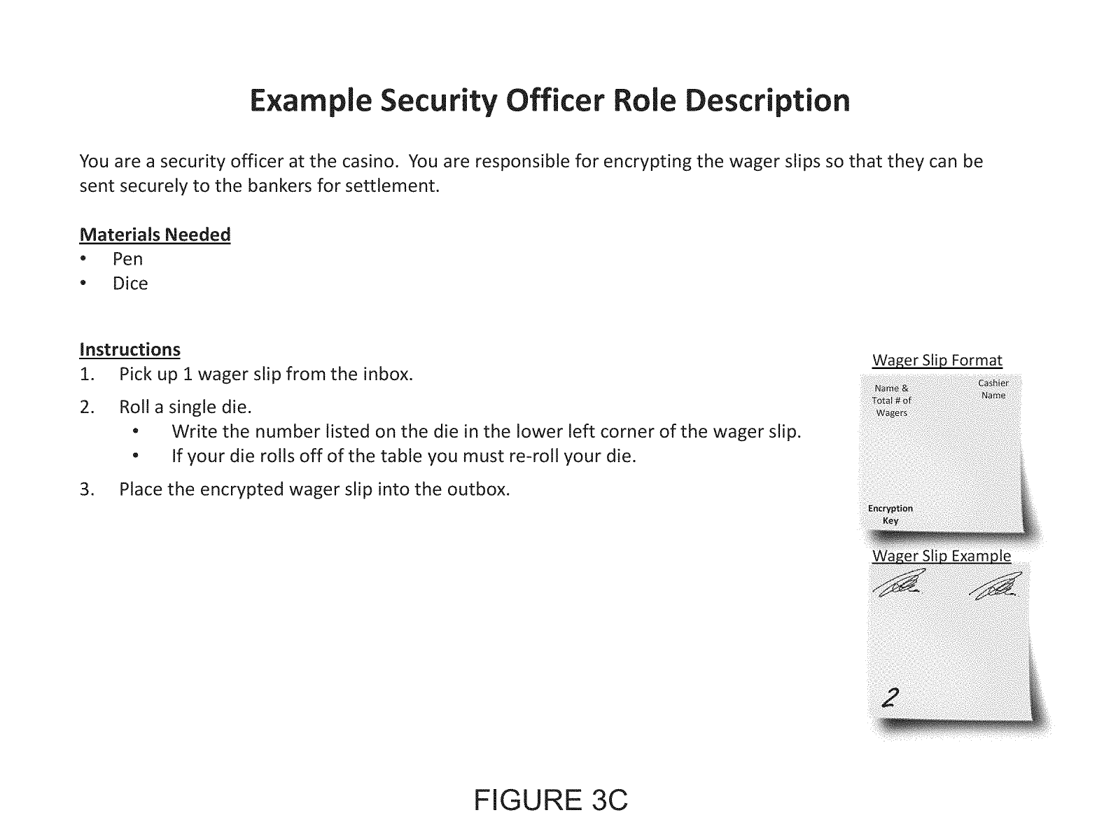

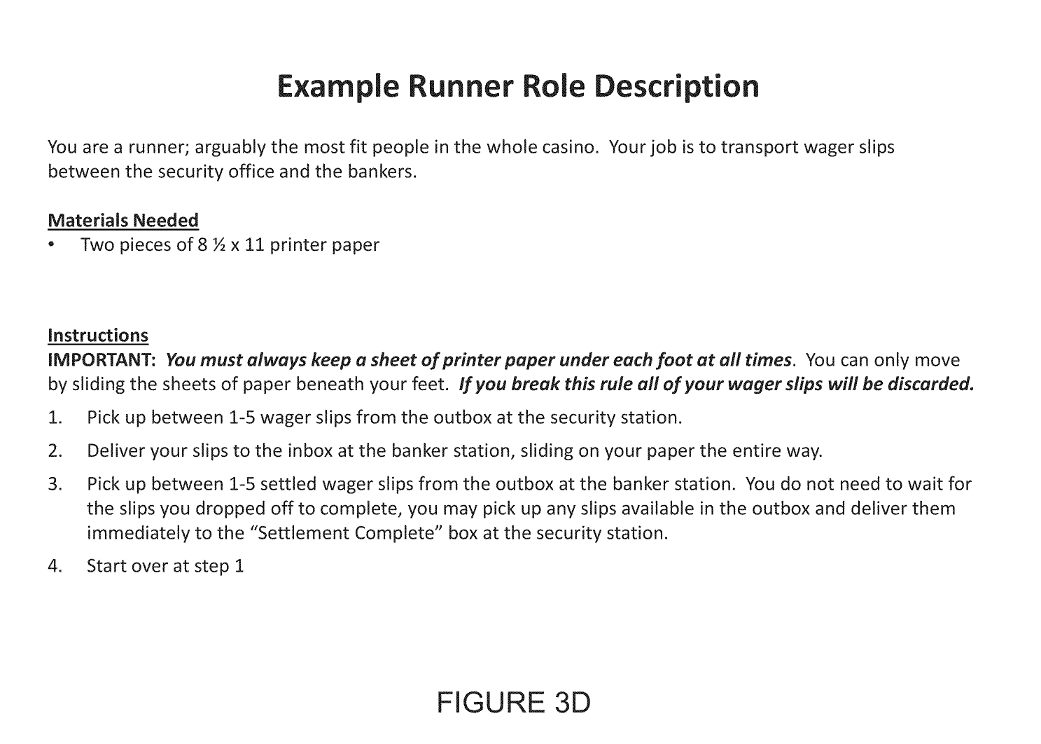

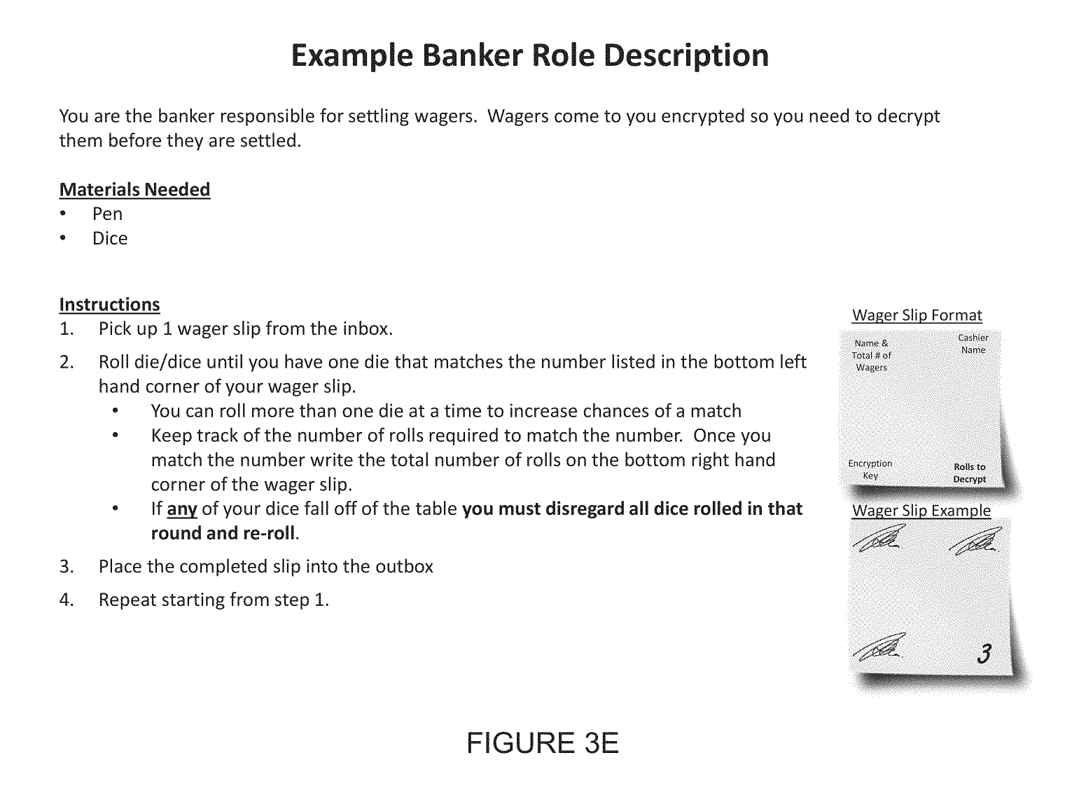

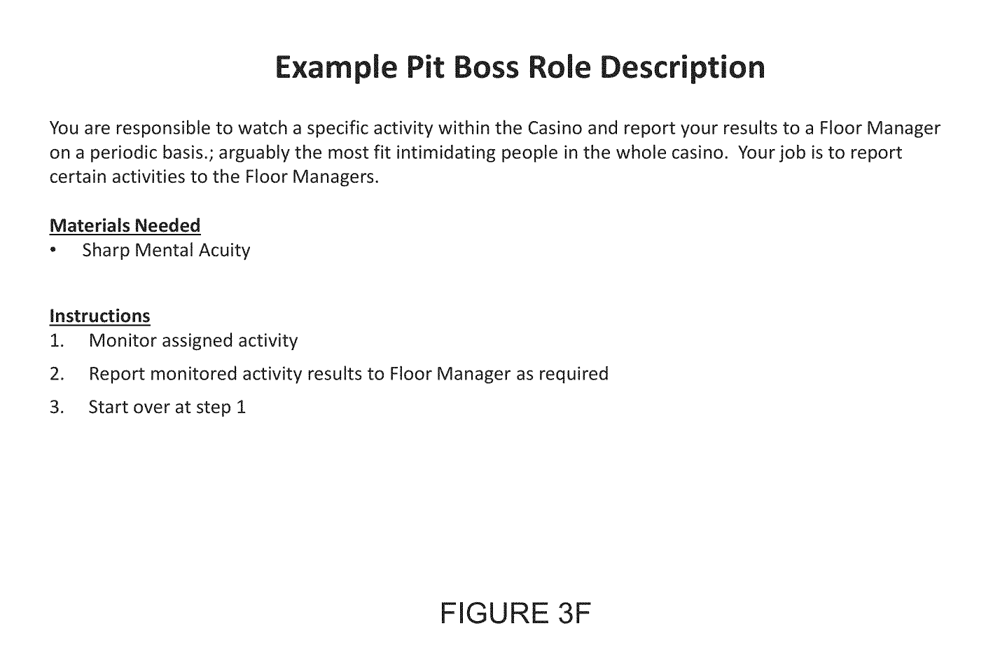

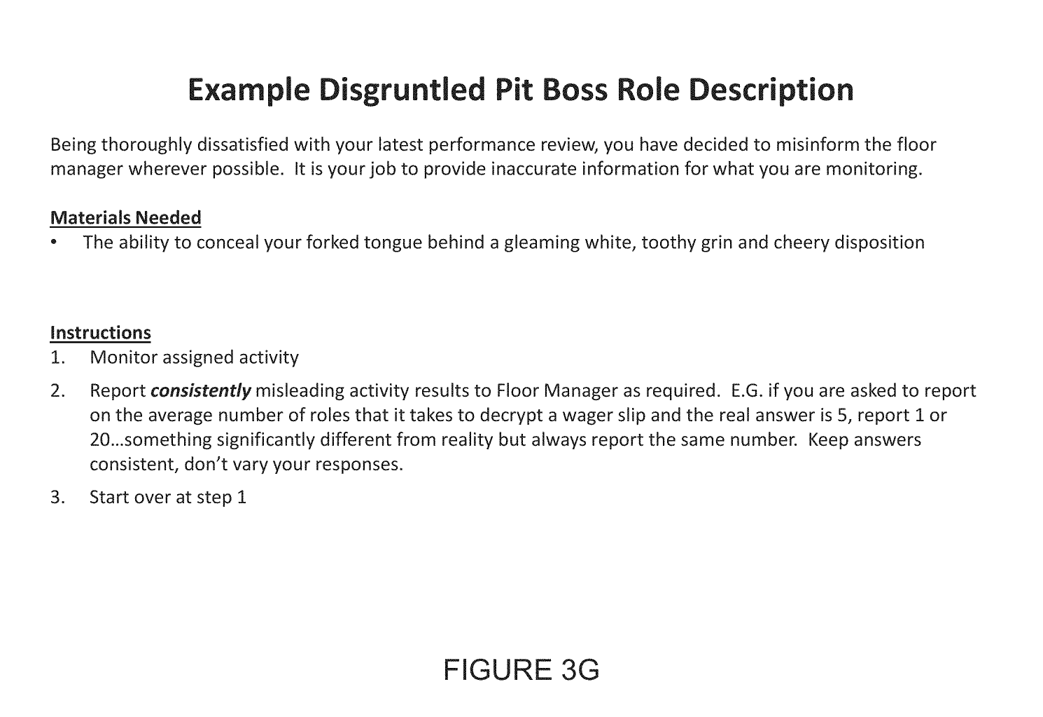

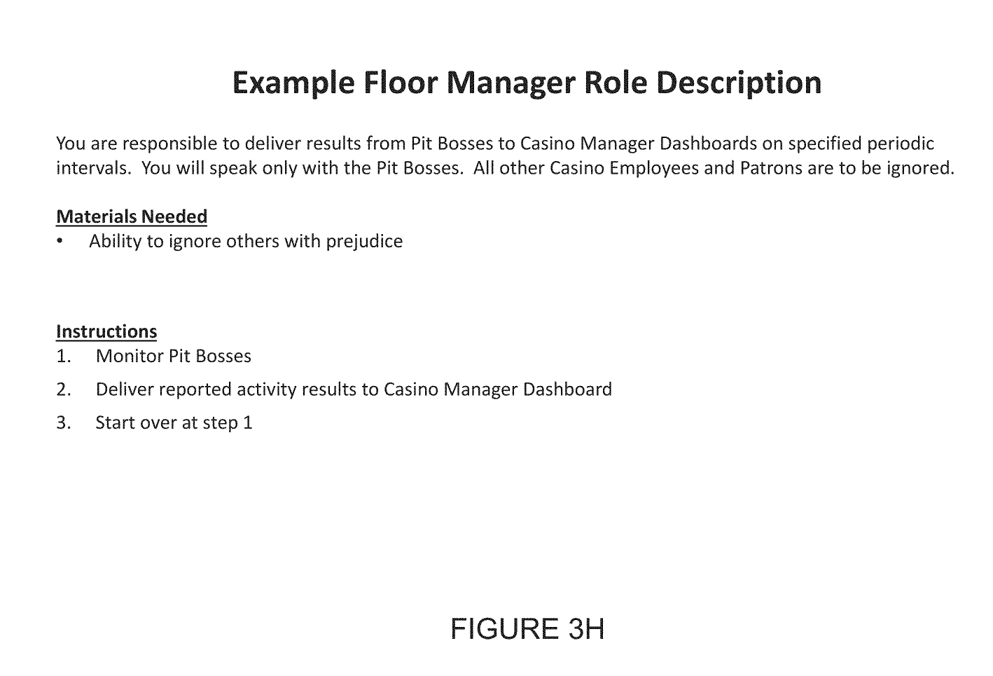

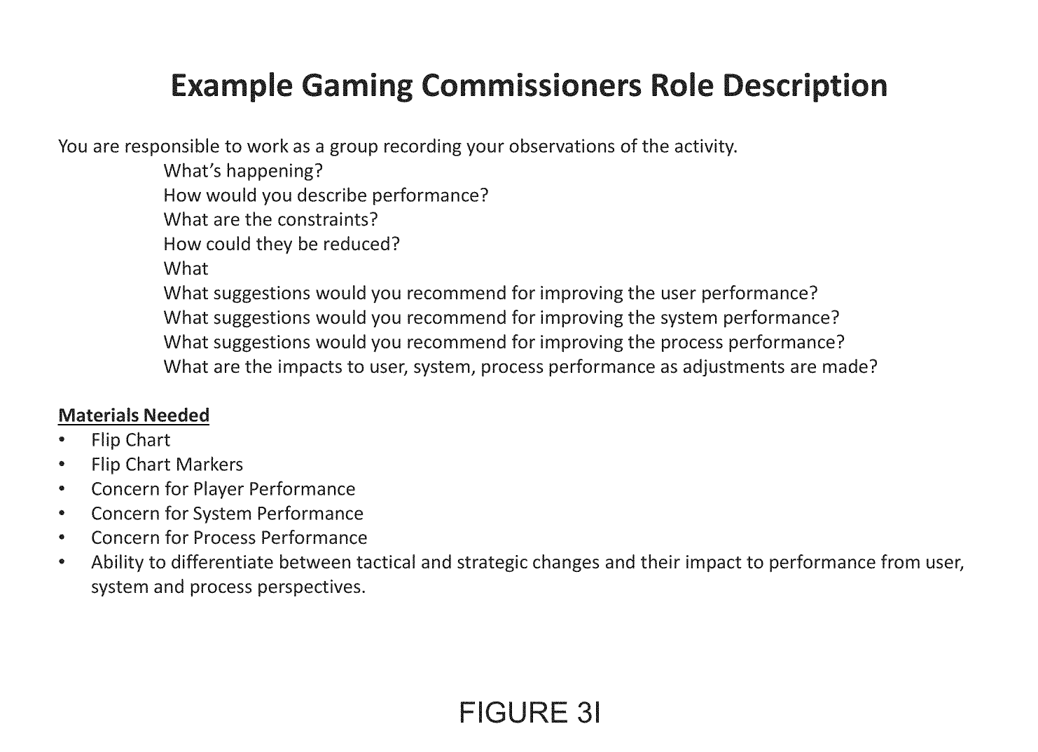

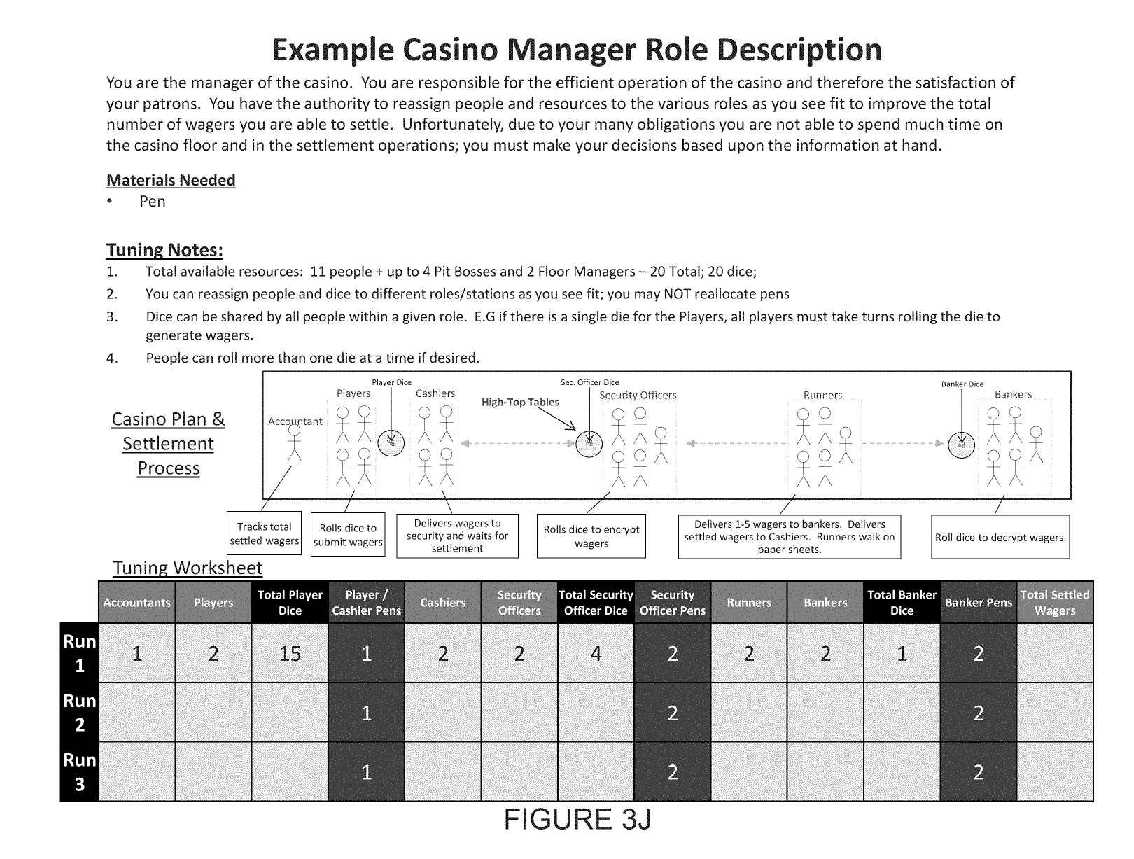

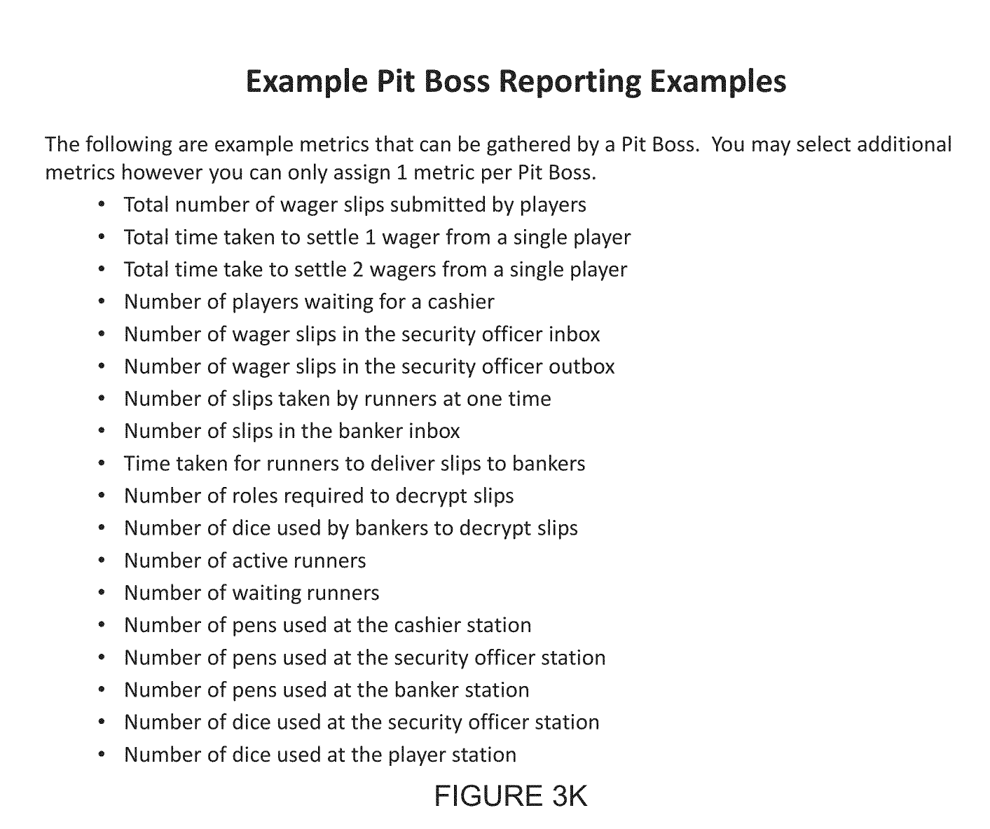

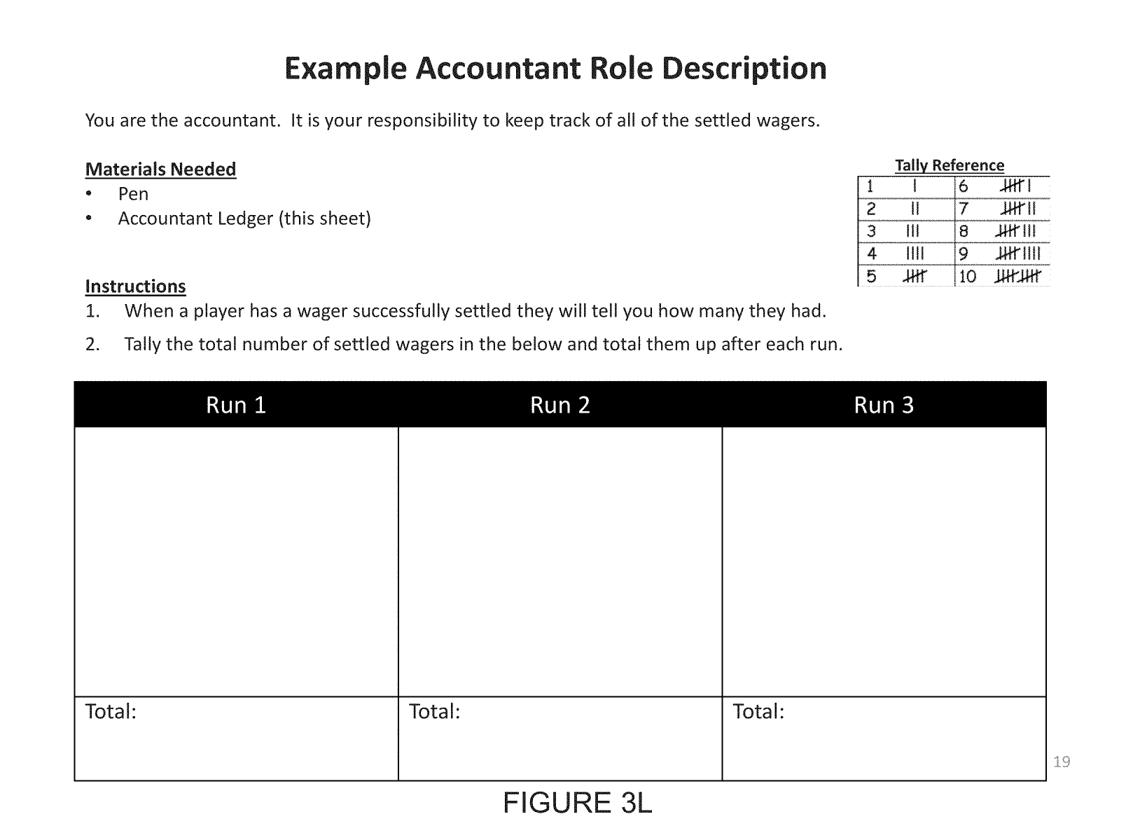

Example role descriptions are provided in FIGS. 3A-3L.

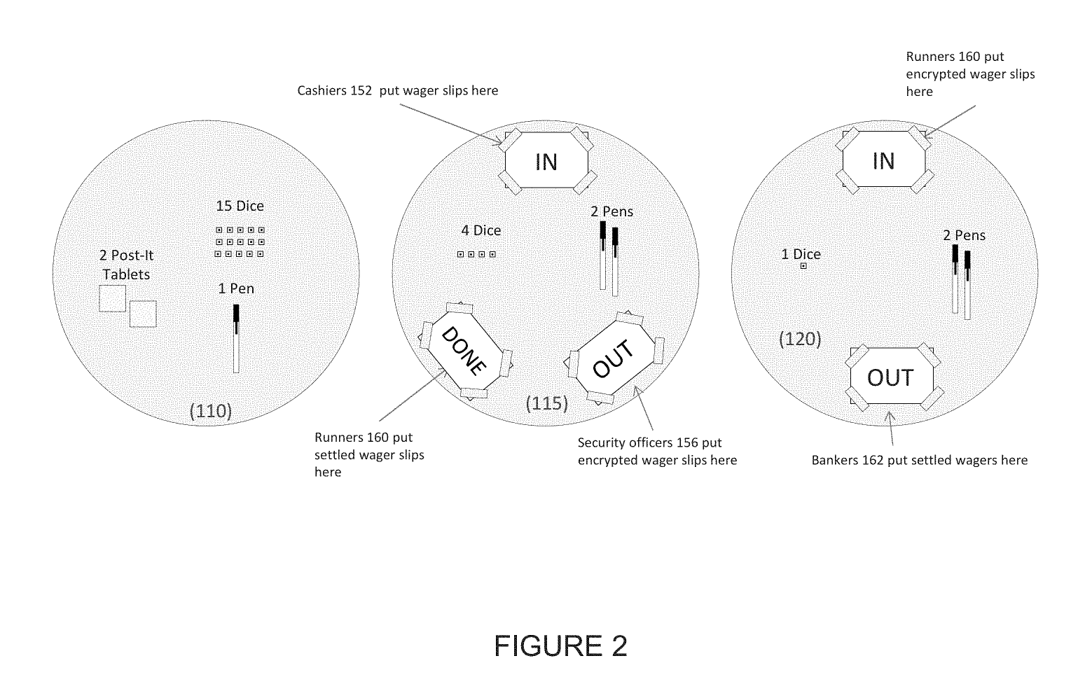

An example initial setup for tables 110, 115, and 120 is depicted in FIG. 2. As shown, tables 110, 115, and 120 may be provided with wager slips, pens, dice, etc.

The participants and the equipment represent different aspects of a computing environment. For example compute resource contention may be represented by limits on dice, pens, paper, and limits on table space for rolling. Latency may be represented by cashiers 152 (e.g., low latency as no paper is used) and runners 160 (e.g., high latency because paper is used). Input/output (I/O) may be represented by the pens or other writing instruments. Importance of monitoring (APM) may be represented by casino manager 166′s inability to watch the action firsthand. The ability to add monitoring is represented by pit bosses 154 and floor managers 158. The unpredictable nature of client behavior may be represented by “player surges.” The iterative nature of tuning may be represented by the difficulty in getting a process right on the first attempt. Risks and complexities of multithreading may be represented by the possibility of bankers 162 rolling many dice at once, as this increases the likelihood of dropping one or more die and forcing a re-roll. Batch/bulk processing may be represented by runners 160 being able to handle up to five items at once. Synchronous versus asynchronous is represented by cashiers 152 (synchronous) and runners 160 (asynchronous). “Resource hogs” may be represented by bankers 162 being able to use as many dice as they want (e.g., do they share equally or do they hog?).

Questions following the experience may include an identification of resource constraints after tuning (e.g., more tables, more pens, etc.) or how the system could be re-architected or re-engineered.

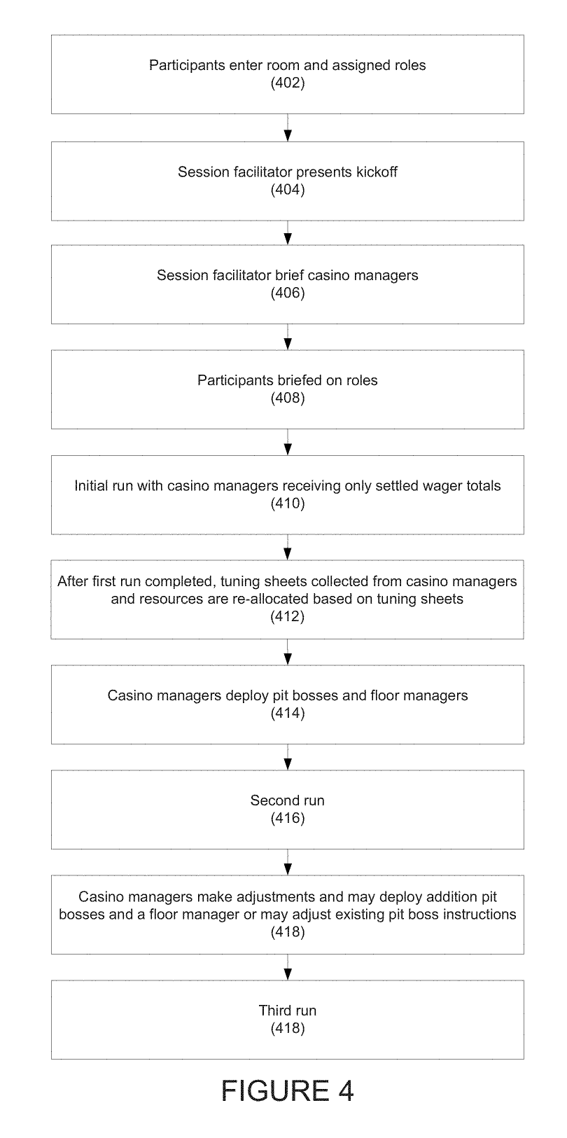

An example session overview is provided in FIG. 4.

First, in step 402, participants enter the room and may “self-assign” by going to an open spot as specified by the sheet of paper for role description (for example, one of the roles identified in FIGS. 3A-3L). Participants may not be allowed to read the role descriptions until specified, and may only be allowed to read other roles.

In step 404, a session facilitator presents brief kickoff, explaining the overall structure and objective. The objective is to settle as many transactions as possible, and each participant is to perform according to his or her role description. Each participant may know only his or her role and not the roles of others.

In step 406, the session facilitator may provide the casino managers with a detailed overview of the entire system, the roles, and the rules governing each role. Casino managers may be given the following: (1) Casino Manager Role description; (2) Casino settlement operations process flow sheet; and (4) initial table setup sheet.

In one embodiment, the session facilitator may explain the “tuning” sheet to the casino managers and the variables that can be adjusted in the casino.

In step 408, other participants may be briefed on their roles and may practice as is necessary and/or desired. In one embodiment, team facilitators may provide this briefing.

In step 410, the session facilitator may start an initial run of the exercise. During this period casino managers will remain with their backs to the action and may make initial tuning recommendations with only input being settled wager totals provided by the accountants; no other inputs may be received.

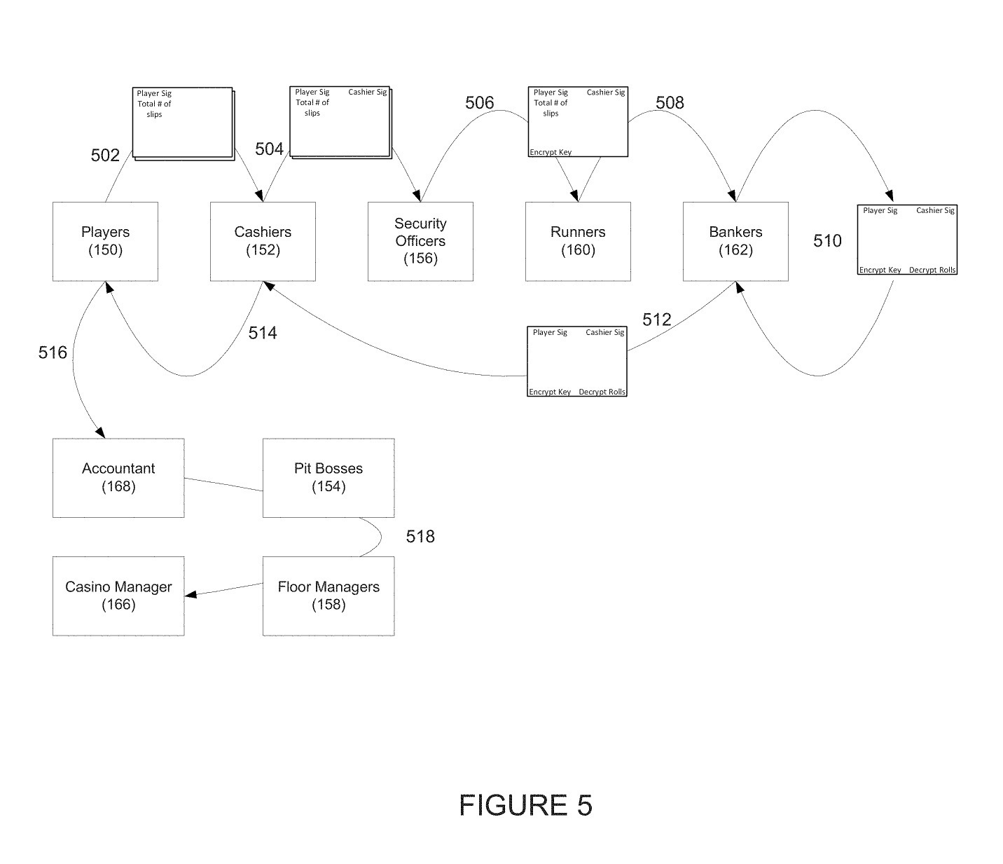

An example of a run process is provided in FIG. 5, below.

In step 412, after the completion of the first run, session facilitator may gather the tuning sheets from the casino managers and bring the casino managers back into the room. The tuning sheets may be provided to each team facilitator, and the team facilitators may re-allocate the resources as per the tuning sheets.

In step 414, the casino managers may also deploy pit bosses (e.g., two) to measure specific items and a floor manager who will report findings from pit bosses. The casino managers may indicate what they want monitored and frequency of reporting.

In step 416, a second run may be performed. The casino managers may be provided with additional insights by the dashboard updates made by the floor managers and the settled wagers tally provided by the accountant.

In step 418, after the completion of the second run, the casino managers may review the data from the accountant and use that input as well as their own observations and feedback from their teams to make a final round of adjustments. Casino managers may make adjustments using the tuning sheets and may deploy additional pit bosses (e.g., two) and an additional floor manager, or may make adjustments to existing pit boss instructions.

In step 420, a third run may be executed, and a session debrief may be conducted after results are announced.

Referring to FIG. 5, an example casino settlement operations process flow is provided according to one embodiment.

In step 502, players roll die to determine number of wagers they can make. For example, if the player rolls an odd number, the player may make a single wager; if the player rolls an even number, the player may make two wagers. The players then sign their wager slip with the total number of wagers being submitted in the top left corner. Players wait for settled wagers.

Players can submit up to 2 wagers at a time

In step 504, the cashiers may pick up the wager slip(s), and may sign them in the top right corner. The cashiers may then walk the slips to the security office and place slips in the inbox.

Cashiers then wait at the outbox for all of their wagers for a player to be processed. The cashiers can return wagers to the players when all wagers for that player are processed.

Cashiers can handle up to 3 players at a time.

In step 506, the security officers pick up one slip and roll a die to determine the encryption code. They then write the encryption code (i.e., the number on the die) on the bottom left corner of the slip and place in the out box for settlement.

Security officers can process 1 wager at a time.

In step 508, the runners may take up to 5 encrypted slips from the out box at the security office to the in box at the banker station.

In one embodiment, the runners must “slide” on paper or some other material to deliver the wagers.

After delivery, the runners may go to the out box at the banker station. Runners do not need to wait for delivered slips to be settled.

Runners can carry up to 5 slips at a time.

In step 510, the bankers may pick up one slip from the banker in box, and may roll a die or dice until the die or dice match the encryption code listed on the slip. After matching the code, the bankers write the total number of rolls required to match the code in the bottom right corner of the slip and place the slip in the out box.

Bankers can process 1 slip at a time

In step 512, after dropping their slips at the banker station in box, the runners may take up to five slips from the out box at the banker station and deliver them back to the cashiers, bypassing the security office. Runners may take any slips—they do not need to be the same slips that the runner dropped off in the in box.

Runners can carry up to five slips at a time, and may be required to slide on paper or other material to deliver the settled wagers.

In step 514, the cashiers review the settled wagers looking for their slips. Once they obtain the complete set of slips for one of their players (as indicated by the cashier signature, player signature, and total wager count) they return the complete set or sets of wager slips back to the player(s) to whom they belong.

Cashiers must complete settlement for all of the players that they are currently handling before handling new players.

In step 516, upon receiving their settled wagers, the players verify they have received the correct slips. Once verified, the players notify the accountant of how many settled wagers they have received. After notifying the accountant, they roll the die and resubmit new wagers.

In step 518, the pit bosses may monitor assigned activity and report to the floor managers. The floor managers may provide periodic updates (e.g., total number of settled wagers, the average number of rolls to decrypt a wager slip, etc.) to the casino managers using the dashboard.

Examples of things that may be reported are shown in FIG. 3K.

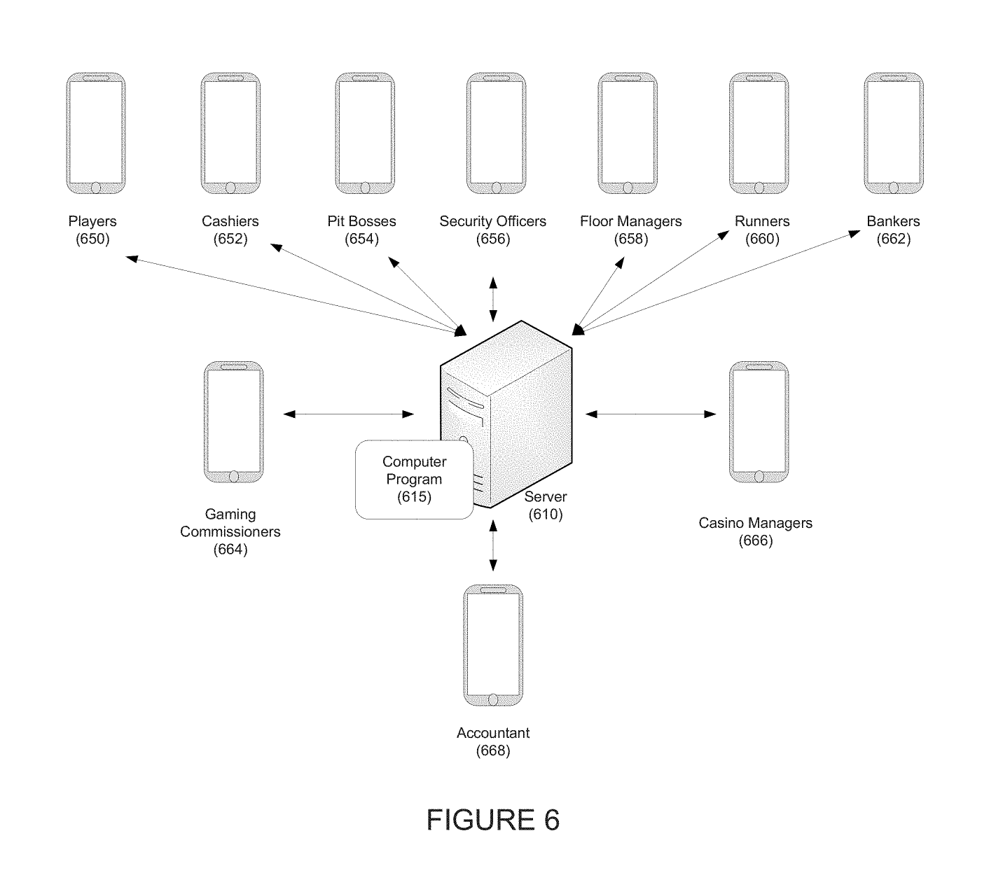

Although embodiments have been written in the context of a manual activity involving paper, dice, etc., other embodiments may be implemented as a partially or wholly computer based game. Referring to FIG. 6, in one embodiment, electronic device 610 may interact with participants using mobile devices, such as players 650, cashiers 652, pit bosses 654, security officers 656, floor managers 658, runners 660, bankers 662, gaining commissioners 664, casino managers 666, and accountant 668. Computer program 620 executed by electronic device 610 may control the interaction between the participants, and may require actions that simulate actions that are taken in the in-person simulation. For example, to simulate the activity of runners 160, runners 260 may need to complete a challenge on their electronic device, such as navigating a graphical maze, solving a math problem, riddle, etc. Cashiers 652 may select a number of dice to roll, and dice may randomly “fall” off the screen, simulating the potential of physical dice falling off of a table. Participants may annotate virtual notecards, and misleading information, unexpected delays, etc. may be interjected into the simulation. Participant-to-participant chat may allow certain participants to report to others.

In embodiments, all of the participants may participate in the simulation using electronic devices. In another embodiment, some participants may participate using electronic devices, and others may participate in person.

Other electronic implementations may be used as is necessary and/or desired.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A gamified method of teaching engineering principles using a virtual casino environment, comprising:
in an information processing apparatus comprising at least one computer processor:
assigning each of a plurality of participants a role selected from the group consisting of players, cashiers, security officers, runners, bankers, pit bosses, casino managers, and an accountant, each participant associated with an electronic device;
controlling a plurality of interactions between the participants in a virtual casino environment, wherein, using their respective electronic device:
the players roll virtual die to determine a number of wagers to make;
the players create virtual wager slips based on the determined number of wagers;
the cashiers receive the virtual wager slips and communicate the virtual wager slips to the security officers;
the security officer roll a virtual die and annotate the virtual wager slips with the number on the virtual die;
the runners receive the annotated virtual wager slips and communicate the annotated virtual wager slips to the bankers;
the bankers roll a virtual die until the number on the virtual die matches the number on the annotated virtual wager slips, and the bankers further annotate the virtual wager slips with the number of rolls of the virtual die needed to match the number on the virtual wager slip;
the runners receive the further annotated virtual wager slips and communicate the further annotated virtual wager slips to the cashiers;
the cashiers settle the wagers by matching the further annotated wager slips to the wager slips and returning the further annotated wager slips to the player that submitted the wager slip;
the players report the settled wager to the accountant;
the pit bosses monitor the activity of the players, the cashiers, and the bankers, and report the activity to the floor managers; and
the floor managers report the activity to the casino manager.

2. The method of claim 1, wherein the number of wagers is based on the virtual die role being odd or even.

3. The method of claim 1, wherein the virtual wager slips, the annotated virtual wager slips, and the further annotated virtual wager slips are communicated electronically.

4. The method of claim 1, wherein the runners communicate the annotated virtual wager slips to the bankers and communicate the further annotated virtual wager slips to the cashiers by completing a challenge on their electronic devices.

5. The method of claim 4, wherein the challenge is the completion of a graphical maze, a riddle, or a math problem.

6. The method of claim 1, further comprising:
updating a dashboard based on the settled wagers received by the accountant.

7. The method of claim 1, further comprising:
the casino managers submitting a first resource reallocation request following a first completion of the simulation, and repeating the first simulation with additional resources identified in the first resource reallocation request.

8. The method of claim 7, wherein the additional resources comprises a first assignment of additional pit bosses and floor managers.

9. The method of claim 7, further comprising:
the casino managers submitting a second resource reallocation request following a second completion of the simulation, and repeating the second simulation with additional resources identified in the second resource reallocation request.

10. The method of claim 9, wherein the resource reallocation comprises a second assignment of additional pit bosses and floor managers.

11. A gamified system for teaching engineering principles using a virtual casino environment, comprising:
an electronic device comprising at least one computer processor; and
a plurality of participant electronic devices, each participant electronic device associated a plurality of participant, each participant assigned a role selected from the group consisting of players, cashiers, security officers, runners, bankers, pit bosses, casino managers, and an accountant;
wherein a computer program executed by the electronic device controls a plurality of interactions between the participants in a virtual casino environment, wherein, using their respective electronic device:
the players roll virtual die to determine a number of wagers to make;
the players create virtual wager slips based on the determined number of wagers;
the cashiers receive the virtual wager slips and communicate the virtual wager slips to the security officers;
the security officer roll a virtual die and annotate the virtual wager slips with the number on the virtual die;
the runners receive the annotated virtual wager slips and communicate the annotated virtual wager slips to the bankers;
the bankers roll a virtual die until the number on the virtual die matches the number on the annotated virtual wager slips, and the bankers further annotate the virtual wager slips with the number of rolls of the virtual die needed to match the number on the virtual wager slip;
the runners receive the further annotated virtual wager slips and communicate the further annotated virtual wager slips to the cashiers;
the cashiers settle the wagers by matching the further annotated wager slips to the wager slips and returning the further annotated wager slips to the player that submitted the wager slip;
the players report the settled wager to the accountant;
the pit bosses monitor the activity of the players, the cashiers, and the bankers, and report the activity to the floor managers; and
the floor managers report the activity to the casino manager.

12. The system of claim 11, wherein the number of wagers is based on the virtual die role being odd or even.

13. The system of claim 11, wherein the virtual wager slips, the annotated virtual wager slips, and the further annotated virtual wager slips are communicated electronically.

14. The system of claim 11, wherein the runners communicate the annotated virtual wager slips to the bankers and communicate the further annotated virtual wager slips to the cashiers by completing a challenge on their electronic devices.

15. The system of claim 14, wherein the challenge is the completion of a graphical maze, a riddle, or a math problem.

16. The system of claim 11, further comprising:
updating a dashboard based on the settled wagers received by the accountant.

17. The system of claim 11, further comprising:
the casino managers submitting a first resource reallocation request following a first completion of the simulation, and repeating the first simulation with additional resources identified in the first resource reallocation request.

18. The system of claim 17, wherein the additional resources comprises a first assignment of additional pit bosses and floor managers.

19. The system of claim 17, further comprising:
the casino managers submitting a second resource reallocation request following a second completion of the simulation, and repeating the second simulation with additional resources identified in the second resource reallocation request.

20. The system of claim 9 wherein the resource reallocation comprises a second assignment of additional pit bosses and floor managers.
